(19) United States
(12) Patent Application Publication
(10) Pub. No.: US 2009/0016361 A1
(43) Pub. Date: Jan. 15, 2009

(54) SYSTEM AND METHOD FOR ESTABLISHING COMMUNICATIONS BETWEEN PACKET-SWITCHED NETWORKS

(75) Inventors: YETIK SERBEST, AUSTIN, TX (US); ERIC PUETZ, GEORGETOWN, TX (US); WENGE CHEN, AUSTIN, TX (US); MICHAEL PEPE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/775,063

(22) Filed: Jul. 9, 2007

(51) Int. Cl. H04L 12/56

(52) U.S. Cl. 370/399

(57) ABSTRACT

A system and method for establishing communications between packet-switched networks is disclosed. A system that incorporates teachings of the present disclosure may include, for example, a communication device having a controller element to transmit a packet along a logical tunnel established through an Internet Service Provider (ISP) network. The packet is encoded with a Virtual Circuit (VC) label by a local Ethernet network operating independent from the ISP network. The VC-label of the encoded packet is substantially undetectable by one or more network elements of the ISP network while in route through the logical tunnel. Additional embodiments are disclosed.

### RELATED APPLICATION

U.S. application Ser. No. 11/751,460 filed May 21, 2007 by Serbest et al., entitled “System and Method for Managing Communications.” All sections of the aforementioned application are incorporated herein by reference.

### FIELD OF THE DISCLOSURE

The present disclosure relates generally to communication systems, and more specifically to a system and method for establishing communications between packet-switched networks.

### BACKGROUND

As businesses and the population expand, the providing of inter-city/long-haul communication services becomes more desirable. Inter-city/long-haul communication services can be provided by building an overlay inter-LATA network by laying down fiber; by leasing dark fiber from a long distance service provider; by leasing wavelengths from a long distance service provider; and by leasing circuits such as Packet over SONET (POS), Frame Relay, and ATM from a long distance service provider. However, each of these options can be very expensive and can be a time consuming process. The cost and time spent can be exacerbated by the particular location of the overlay network and its extent.

A need therefore arises for a system and method for establishing communications between packet-switched networks.

### BRIEF DESCRIPTION OF THE DRAWINGS

FIGS. 1-7 depict exemplary embodiments of a communication system;

FIG. 8 depicts an exemplary method operating in one or more of the communication systems of FIGS. 1-7; and

FIG. 9 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and method for establishing communications between packet-switched networks.

In one embodiment of the present disclosure, a computer-readable storage medium in a first network element of a first Autonomous System (AS) can have computer instructions for receiving an Ethernet packet, selecting a Virtual Circuit (VC) label for the Ethernet packet, encoding the Ethernet packet into a new packet with the VC label, and directing the new packet to a second AS through a tunnel traversing an Internet Service Provider (ISP) network. The new packet can be further encoded through the tunnel so that the VC-label of the Ethernet packet is substantially unidentifiable by network elements of the ISP network.

In another embodiment of the present disclosure, a method operating in an ISP network can involve receiving from a first AS over a tunnel traversing the ISP network an encoded Ethernet packet with a VC label. The VC label of the encoded Ethernet packet transported in the tunnel is hidden from one or more network elements of the ISP network.

In another embodiment of the present disclosure, a communication device can have a controller element to transmit a packet along a logical tunnel established through an ISP network. The packet is encoded with a VC label by a local Ethernet network operating independent from the ISP network. The VC-label of the encoded packet is substantially undetectable by one or more network elements of the ISP network while in route through the logical tunnel.

In another embodiment of the present disclosure, a method employed by a first service provider of a first AS can involve the first service provider paying a fee to a second service provider of an ISP network to transport an encoded Ethernet packet with a VC label over a tunnel traversing the ISP network. The encoded Ethernet packet can be substantially undetectable by one or more network elements of the ISP network.

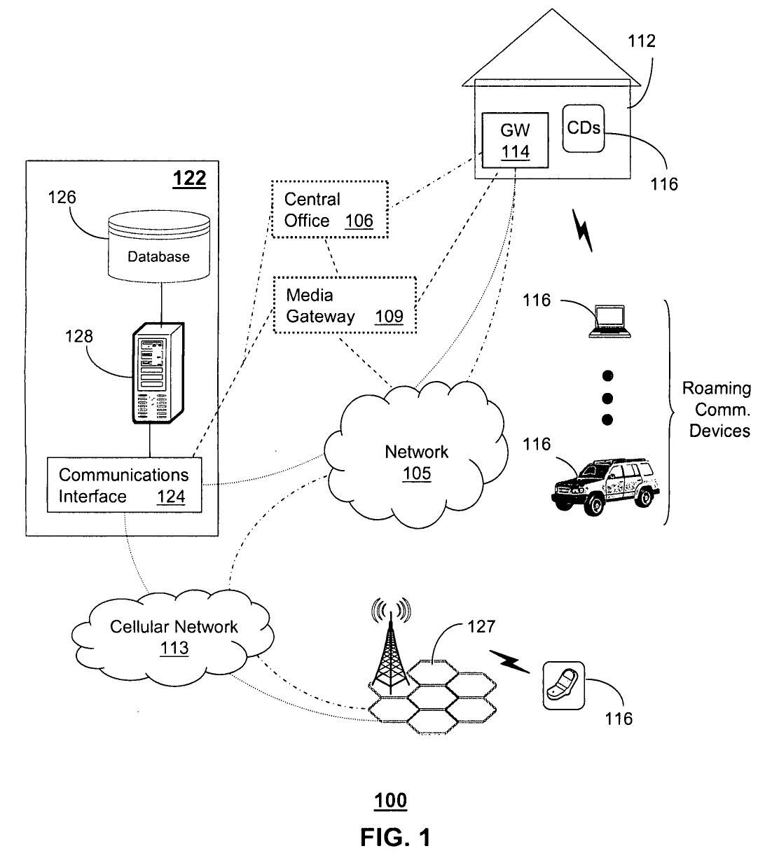

FIG. 1 depicts an exemplary block diagram of a communication system 100 that can supply communication services to one or more fixed and/or roaming communication devices 116. The communication system 100 can comprise a central office (CO) 106 coupled to one or more buildings 112. The CO 106 can house common network switching equipment (e.g., circuit-switched and packet-switched switches and routers) for distributing local and long-distance telecommunication services supplied by network 105 to buildings 112 (such as dwellings or commercial enterprises). It should be understood by one of ordinary skill in the art that the buildings 112 can refer to any premises or areas that utilize communication services.

Telecommunication services of the CO 106 can include traditional POTS (Plain Old Telephone Service) and broadband services such as HDTV, DSL, VoIP (Voice over Internet Protocol), IPTV (Internet Protocol Television), Internet services, and so on. The communication devices 116 can be a portable or fixed VoIP, PSTN, and/or cellular terminal. However, the present disclosure contemplates the use of other types of communication devices, including other types of voice, video and data devices.

As a packet-switched network, network 105 can represent an Internet Service Provider (ISP) network. The network 105 can be coupled to a network proxy 122, a cellular network 113 and network elements, including network elements located in one or more of the buildings 112. As a circuit-switched network, network 105, can provide PSTN services to fixed communication devices 116. In a combined embodiment, network 105 can utilize technology for transporting Internet, voice, and video traffic.

In an enterprise setting, the building 112 can include a gateway 114 that provides voice and/or video connectivity services between communication devices 116, such as VoIP terminals or other forms of communication devices of enterprise personnel. In a residential setting, the building 112 can include a gateway 114 represented by, for example, a residential gateway coupled to central office 106 utilizing conventional telephonic switching for processing calls with third parties.

The network proxy 122 can be used to control operations of a media gateway 109, the central office 106 and/or the gateway 114. Communications between the network proxy 122, the communication devices 116 and other network elements of the communication system 100 can conform to any number of signaling protocols such as a session initiation protocol (SIP), or a video communications protocol such as H.323 which combines video and voice over a packet-switched network.

The network proxy 122 can comprise a communications interface 124 that utilizes common technology for communicating over an IP interface with the network 105, the media gateway 109, the cellular network 113, and/or the gateway 114. By way of the communications interface 124, the network proxy 122 can direct by common means any of the foregoing network elements to establish packet switched data, voice, and/or video connections between communication devices 116 distributed throughout the communication system 100. The network proxy 122 can further comprise a memory 126 (such as a high capacity storage medium) embodied in this illustration as a database, and a controller 128 that makes use of computing technology such as a desktop computer, or scalable server for controlling operations of the network proxy 122. The network proxy 122 can operate as an IP Multimedia Subsystem (IMS) conforming in part to protocols defined by standards bodies such as 3GPP (Third Generation Partnership Protocol).

Under the control of the network proxy 122, the media gateway 109 can link packet-switched and circuit-switched technologies such as the cellular network 113 (or central office 106) and the network 105, such as an ISP network. The media gateway 109 can conform to a media gateway control protocol (MGCP) also known as H.248 defined by work groups in the Internet Engineering Task Force (IETF). This protocol can handle signaling and session management needed during a multimedia conference. The protocol defines a means of communication which converts data from the format required for a circuit-switched network to that required for a packet-switched network. MGCP can therefore be used to set up, maintain, and terminate calls between multiple disparate network elements of the communication system 100. The media gateway 109 can therefore support hybrid communication environments for communication devices 116, including VoIP terminals.

The cellular network 113 can support voice and data services over a number of access technologies such as GSM-GPRS, EDGE, CDMA-1X, UMTS, WiMAX, software defined radio (SDR), and other known and future technologies. The cellular network 113 can be coupled to base stations 127 under a frequency-reuse plan for communicating over-the-air with roaming VoIP terminals 116. The communication system 100 can utilize common computing and communications technologies to support circuit-switched and/or packet-switched communications, including MPLS.

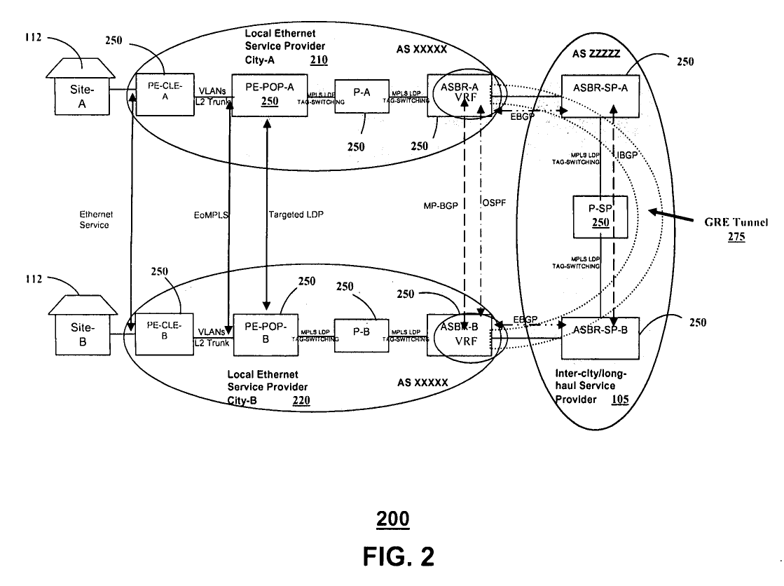

FIG. 2 depicts an exemplary embodiment of a communication system 200 that can include the ISP network 105 and two or more local access and transport areas (LATAs) or networks 210 and 220, such as local Ethernet service provider networks. The communication system 200 can be overlaid or operably coupled with communication system 100 as another representative embodiment of communication system 100. In one embodiment, the LATAs 210 and 220 can comprise virtual local area networks (VLANs), such as VLAN hand-offs to customer sites, such as Sites A and B of buildings 112.

The geographic area of the network 105 and LATAs 210 and 220 can vary. In one embodiment, network 105 can be a long-haul Internet service provider capable of operating over large distances, such as inter-city, inter-state, and international communications. In one embodiment, the LATAs 210 and 220 can be located in different cities or other distinct areas.

Each of the network 105 and LATAs 210 and 220 can comprise network elements 250 for communication, including routers for transmitting packets over each of the networks and between the networks. The routers can include provider routers (P), such as provider edge routers (PE) that are customer location equipment (PE-CLE) and point of presence (PE-POP), and autonomous system border routers (ASBR).

In one embodiment a logical tunnel 275, such as a Generic Routing Encapsulation tunnel (GRE) can be established between the LATAs 210 and 220 over the network 105. The packets can be transmitted according to various protocols and combinations of protocols, including Border Gateway Protocol (BGP), External Border Gateway Protocol (EBGP), Ethernet over MPLS (EoMPLS), Internal Border Gateway Protocol (IBGP), Internet Protocol (IP), Layer-2 Tunneling Protocol version 3 (L2TPv3), Label Distribution Protocol (LDP), Multi-Protocol Border Gateway Protocol (MP-BGP), Multi-Protocol Label Switching (MPLS), Open Shortest Path First (OSPF), and Virtual Routing and Forwarding (VRF).

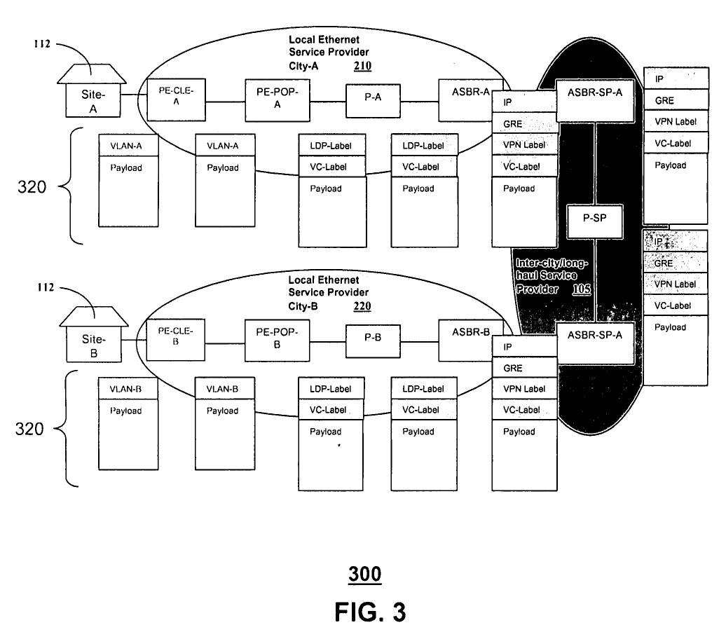

FIG. 3 depicts an exemplary embodiment for transporting packets in communication system 200. Communication system 200 can transmit packet 320 by encoding it with various tags provided by the various network elements 250, including a VLAN label, an LDP label, a Virtual Circuit (VC) Label (which can also be referred to as a pseudo wire), an IP address, a GRE label, and/or a VPN label. In the illustration of FIG. 3, the logical tunnel 275 corresponds to an MPLS Virtual Private Network (MPLS-VPN) tunnel encapsulated by a GRE tunnel of the ISP network 105 which can be used to establish communications between LATAs 210 and 220. The MPLS-VPN tunnel emanates from the LATAs 210, 220 using, for example, Virtual Routing and Forwarding (VRF) tables defined at each end of the LATAs.

The packet 320 can be transmitted by these nested tunnels from Site A to Site B without changing the VC-Label. Packet 320 can also be transmitted over the inter-city/long-haul service provider network 105 without the GRE header, IP header and VPN label being changed. In one embodiment, the services that the local Ethernet service provider is offering by way of LATAs 210 and 220 to Sites A and B can be done so without the inter-city/long-haul service provider being made aware of the VPN connection or the VC-Label assigned to each of the Ethernet packets.

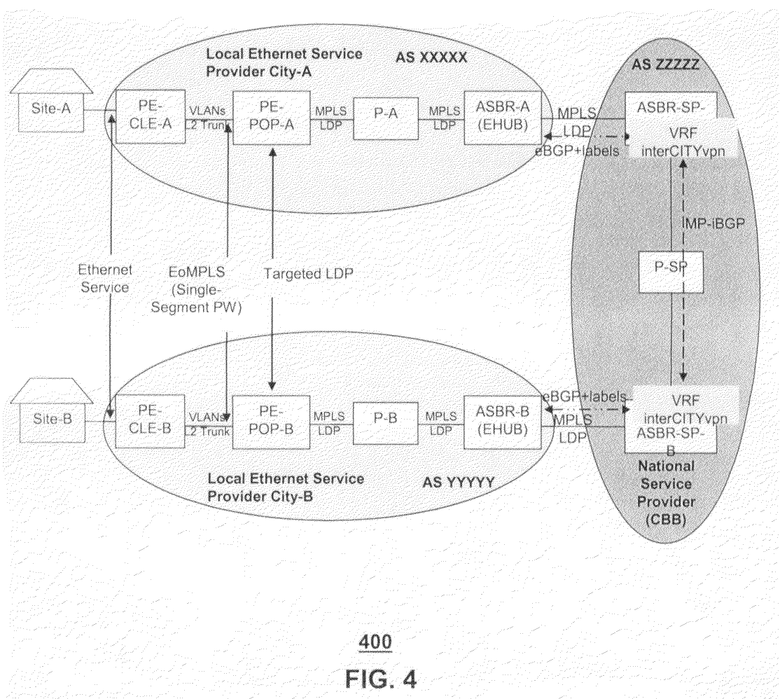

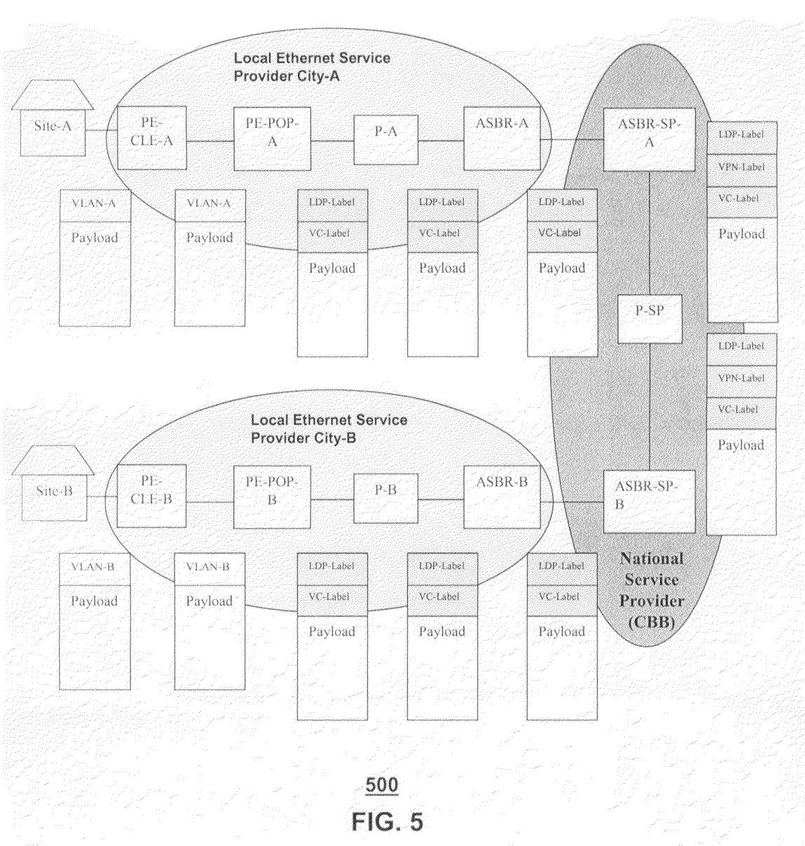

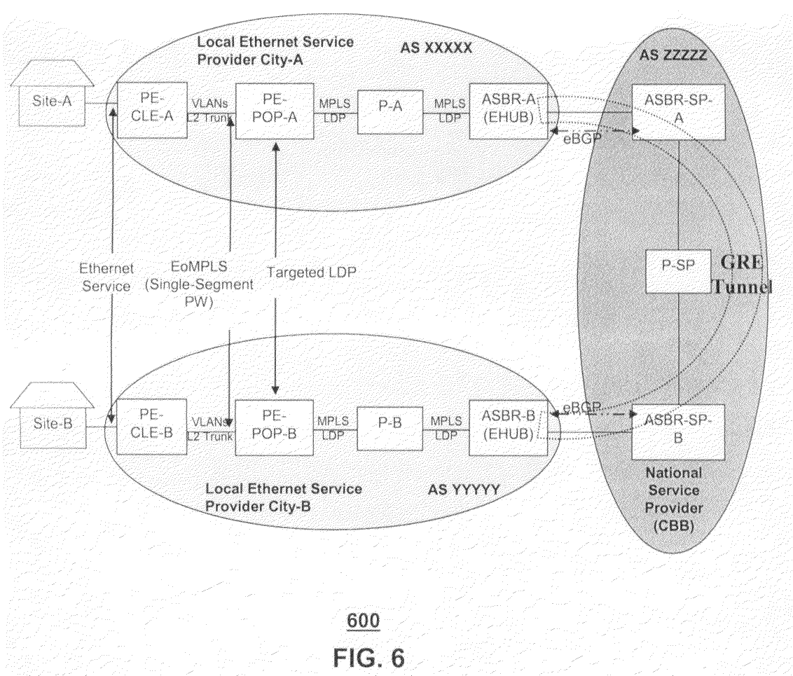

FIGS. 4 and 6 depict communication system embodiments (400 and 600) that can provide alternative embodiments to the tunneling method utilized by communication system 200 of FIGS. 2-3. FIGS. 4-5, for example, depict an alternative embodiment of a communication system 400 in which MPLS packets are transmitted by the LATAs 210, 220 to an MPLS-VPN tunnel emanating from the ISP network 105. The LATAs 210 and 220 can advertise their loopback address to each other by way of the MPLS-VPN tunnel of the ISP network 105. For example, ASBR-A can advertise ASBR-A's/32 IPv4 loopback address to ASBR-SP-A. Similarly, ASBR-B can advertise ASBR-B's/32 IPv4 loopback address to ASBR-SP-B. These loopback addresses can be advertised through a suitable protocol such as EBGP. The ISP network 105 can be programmed to assign MPLS labels to each of the IP addresses to enable communications between the LATAs 210, 220.

As before the services that the local Ethernet service provider is offering by way of LATAs 210 and 220 to Sites A and B can be done so without the inter-city/long-haul service provider of the ISP network 105 being made aware of the VC-Label assigned to each of the Ethernet packets by way of the MPLS-VPN tunnel of the ISP network.

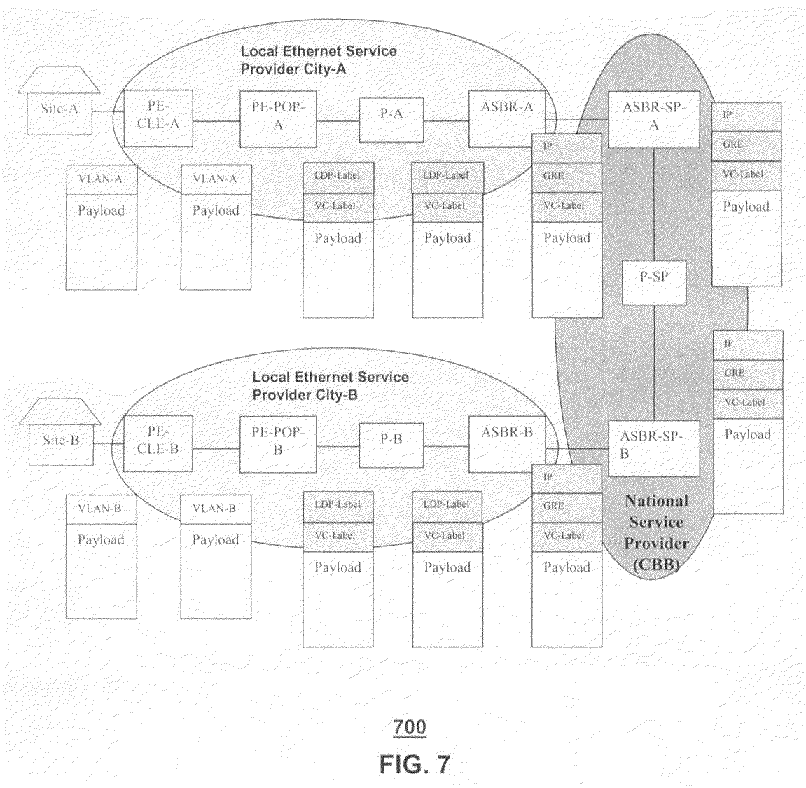

FIGS. 6-7 depict an embodiment of a communication system 600 in which MPLS labels (specifically LDP-labels) are switched with IP-GRE encapsulation in a tunnel traversing the ISP network 105. In this embodiment as well, the Ethernet packets transmitted between Sites A and B are encoded so that the inter-city/long-haul service provider of the ISP network is unaware of the VC-label assigned to the Ethernet packets transported by the end-to-end IP GRE tunnel. This embodiment also provides the added benefit of scalability since tunnels emanate only from ASBRs 250.

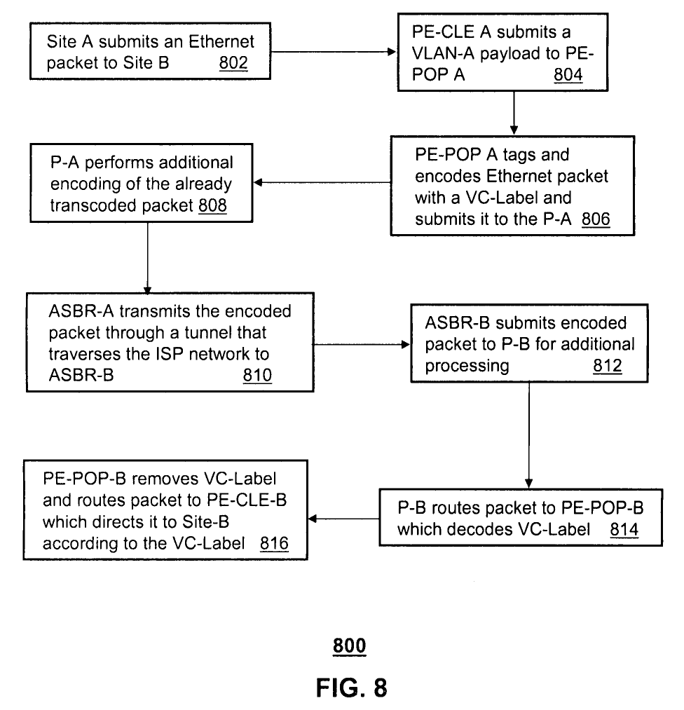

FIG. 8 depicts an exemplary method 800 operating in portions of communication systems 100, 200, 400, and/or 600. It would be apparent to an artisan with ordinary skill in the art that other embodiments not depicted in FIG. 8 are possible without departing from the scope of the claims described below.

Method 800 begins with step 802 in which network elements 250 of LATAs 210 and 220 can transmit Ethernet packets by way of a tunnel that traverses the ISP network 105. For example, Site A can generate an Ethernet packet that is directed to a terminal at Site B. The Ethernet packet is received by PE-CLE A which routes in step 804 the VLAN-A packet to PE-POP A. PE-POP A in turn tags in step 806 the Ethernet packet with a VC-label and encodes it as an MPLS or IP packet directed to PE-POP B. The encoding used depends on which of the aforementioned tunneling techniques is used. The P-A can perform in step 808 additional encoding such as re-labeling an MPLS label to bundle the encoded Ethernet packet with other packets received from other PE-POPs (not shown).

In step 810, the ASBR-A can transmit the encoded packet through one of the above mentioned tunnels (MPLS-VPN to GRE, end-to-end IP GRE, IP-VPN to IP-GRE, and so on) that traverses the ISP network 105. In step 812, the ASBR-B receives the encoded packet from the tunnel coupled thereto and submits it to P-B to identify the PE-POP associated with said packet (in this instance PE-POP B) based on the label provided by P-A. In step 814 P-B routes the packet to PE-POP B. PE-POP B removes in step 816 the VC-label and routes according to said VC-label the Ethernet packet to PE-CLE B. PE-CLE B then delivers the Ethernet packet to a corresponding terminal at Site B as instructed by the payload. Method 800 can be applied symmetrically to Ethernet packets directed from Site B to Site A.

From the foregoing descriptions, it would be evident to an artisan with ordinary skill in the art that the aforementioned embodiments can be modified, reduced, or enhanced without departing from the scope and spirit of the claims described below. For example, the LATAs 210 and 220 and/or the ISP network 105 can establish other types of logical tunnels not presented in this disclosure. Additionally, logical tunnels can be nested with more than two layers and emanate from any network element in the LATAs 210, 220 and/or network elements of the ISP network 105. These are but a few examples of the modifications that can be applied to the present disclosure without departing from the scope of the claims. Accordingly, the reader is directed to the claims for a fuller understanding of the breadth and scope of the present disclosure.

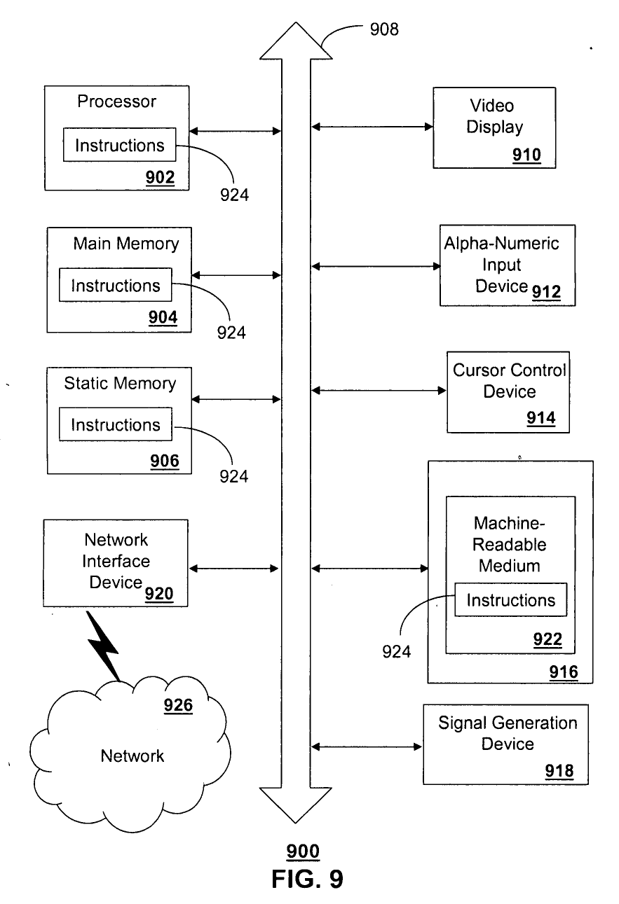

FIG. 9 depicts an exemplary diagrammatic representation of a machine in the form of a computer system 900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a first network element of a first Autonomous System (AS), comprising computer instructions for:
receiving an Ethernet packet;
selecting a Virtual Circuit (VC) label for the Ethernet packet;
encoding the Ethernet packet into a new packet with the VC label; and
directing the new packet to a second AS through a tunnel traversing an Internet Service Provider (ISP) network, wherein the new packet is further encoded through the tunnel so that the VC-label of the Ethernet packet is substantially unidentifiable by network elements of the ISP network.

2. The storage medium of claim 1, wherein the new packet is generated from encoding of the Ethernet packet into one among a Multi-Protocol Label Switching (MPLS) packet, and an Internet Protocol (IP) packet, and wherein the first network element comprises a provider edge router.

3. The storage medium of claim 1, wherein the tunnel comprises an MPLS Virtual Private Network (MPLS-VPN) tunnel of the ISP network.

4. The storage medium of claim 3, wherein the MPLS-VPN tunnel is configured by a Virtual Routing and Forwarding (VRF) table of the ISP network.

5. The storage medium of claim 3, comprising computer instructions for:
transmitting by way of the MPLS-VPN tunnel to a second network element of the second AS a first IP address of the first network element to enable the second network element to establish communications with the first network element; and
receiving by way of the MPLS-VPN tunnel a second IP address of the second network element to enable the first network element to establish communications with the second network element.

6. The storage medium of claim 5, wherein the ISP network assigns a first MPLS label to the first IP address and a second MPLS label to the second IP address.

7. The storage medium of claim 1, wherein the tunnel comprises an MPLS label switched with an IP Generic Route Encapsulation (IP-GRE) encapsulation.

8. The storage medium of claim 1, wherein the first and second network elements each comprise a provider edge router point of presence (PE-POP), and wherein the Ethernet packet originates from a provider edge router customer location equipment (PE-CLE).

9. The storage medium of claim 1, wherein the VC-label comprises a Pseudo-Wire (PW) label).

10. A method operating in an Internet Service Provider (ISP) network, comprising receiving from a first Autonomous System (AS) over a tunnel traversing the ISP network an encoded Ethernet packet with a Virtual Circuit (VC) label, wherein the VC label of the encoded Ethernet packet transported in the tunnel is hidden from one or more network elements of the ISP network.

11. The method of claim 10, wherein the encoded Ethernet packet is generated from encoding of the Ethernet packet into one among a Multi-Protocol Label Switching (MPLS) packet, and an Internet Protocol (IP) packet.

12. The method of claim 10, wherein the tunnel comprises an MPLS Virtual Private Network (MPLS-VPN) tunnel of the ISP network configured by a Virtual Routing and Forwarding (VRF) table of the ISP network.

13. The method of claim 12, comprising:
transmitting to a second AS over the MPLS-VPN tunnel a first IP address of the first AS to enable the second AS to establish communications with the first AS; and
transmitting to the first AS over MPLS-VPN tunnel a second IP address of the second AS to enable the first AS to establish communications with the second AS.

14. The method of claim 13, comprising assigning a first MPLS label to the first IP address and a second MPLS label to the second IP address.

15. The method of claim 10, wherein the tunnel comprises an MPLS label switched with an IP Generic Route Encapsulation (IP-GRE) encapsulation.

16. A communication device, comprising a controller element to transmit a packet along a logical tunnel established through an Internet Service Provider (ISP) network, wherein the packet is encoded with a Virtual Circuit (VC) label by a local Ethernet network operating independent from the ISP network, and wherein the VC-label of the encoded packet is substantially undetectable by one or more network elements of the ISP network while in route through the logical tunnel.

17. The communication device of claim 16, wherein the local Ethernet network encodes the packet into one among a Multi-Protocol Label Switching (MPLS) packet, and an Internet Protocol (IP) packet with the VC-label.

18. The communication device of claim 16, wherein the encoded packet is transmitted along the local Ethernet network before reaching an infrastructure of the ISP network, and wherein the encoded packet is received by another communication device of another local Ethernet network by way of the ISP network by the logical tunnel.

19. The communication device of claim 16, wherein the logical tunnel comprises one among an MPLS Virtual Private Network (MPLS-VPN) tunnel of the ISP network configured by a Virtual Routing and Forwarding (VRF) table of the ISP network, and an MPLS label switched with an IP Generic Route Encapsulation (IP-GRE) encapsulation.

20. A method employed by a first service provider of a first Autonomous System (AS), comprising the first service provider paying a fee to a second service provider of an Internet Service Provider (ISP) network to transport an encoded Ethernet packet with a Virtual Circuit (VC) label over a tunnel traversing the ISP network, wherein the encoded Ethernet packet is substantially undetectable by one or more network elements of the ISP network.

21. The method of claim 20, wherein the encoded Ethernet packet is generated from encoding of an Ethernet packet into one among a Multi-Protocol Label Switching (MPLS) packet, and an Internet Protocol (IP) packet.

22. The method of claim 20, wherein the tunnel comprises one among an MPLS Virtual Private Network (MPLS-VPN) tunnel of the ISP network configured by a Virtual Routing and Forwarding (VRF) table of the ISP network, and an MPLS label switched with an IP Generic Route Encapsulation (IP-GRE) encapsulation.
